(19) United States
(12) Patent Application Publication
(10) Pub. No.: US 2011/0106975 A1
(43) Pub. Date: May 5, 2011

(54) DATA TRANSFER APPARATUS

(75) Inventor: Naoki INOMATA, Kanagawa (JP)

(73) Assignee: Sony Corporation, Tokyo (JP)

(21) Appl. No.: 12/891,034

(22) Filed: Sep. 27, 2010

(30) Foreign Application Priority Data
Nov. 2, 2009 (JP) 2009-251712

(51) Int. Cl. G06F 15/173

(52) U.S. Cl. 709/244

(57) ABSTRACT

There is provided a data transfer apparatus including a first virtual network device which is connected to a downstream port of a first device mounted with a serial transfer interface, a first cable for extending a downstream port of a second device mounted with a serial transfer interface, a second virtual network device which is connected to the first cable, a second cable for extending a downstream port of a third device mounted with a serial transfer interface, a third virtual network device which is connected to the second cable, and a virtual network switch which is connected to the first virtual network device, the second virtual network device and the third virtual network device.

### BACKGROUND OF THE INVENTION

1. Field of the Invention

The present invention relates to a data transfer apparatus.

2. Description of the Related Art

In the related art, networks as represented by Ethernet (registered trademark), Fibre Channel, InfiniBand and the like are used for data transfer between multiple devices.

In order to configure a network, a network card such as Network Interface Card (NIC), Host Card Adapter (HCA) or the like, a network switch, and a network cable are used.

When wideband at a data rate equal to or higher than 20 Gbps is to be realized in a network, in the case of Ethernet, multiple 10 Gigabit Ethernets (10 GbEther) need to be used, which leads to a very high-cost system. Also, in the case of InfiniBand, a very high-cost system will be created because it is necessary to support 4×DDR (Double Data Rate).

Furthermore, when a wideband network needs to be used, bus speed in a device also needs to be high. As a wideband bus well known is a PCI Express (hereafter, referred to as “PCIe”), which is used in a personal computer (PC) or the like.

The typical PCIe includes a root complex, a PCIe switch and an endpoint, and has a Tree structure. In the configuration of the PCIe, the termination of a bus is always a downstream port, and in conformity with the PCIe standard of the PCI-SIG, only an endpoint or a PCIe switch may be connected to the downstream port.

A technique is proposed in which a PCIe switch is logically or physically provided at the end of a downstream port and an endpoint is connected to the end of the PCIe switch (see JP-T-2007-529813, for example).

### SUMMARY OF THE INVENTION

However, connection between downstream ports is generally established, by connecting the downstream ports of different devices each mounted with a PCIe by use of a network or the like. That is, it is common to utilize a network in order to connect downstream ports of different devices each mounted with a PCIe to each other.

As described above, a very high-cost network configuration will be needed in order to realize wideband in a network. Further, in constructing a network, a protocol of a specification such as TCP/IP or the like is needed. Therefore, there is an issue that a big delay occurs in a NIC or a network switch and latency grows bigger.

In light of the foregoing, it is desirable to provide a novel and improved data transfer apparatus, with an inexpensive configuration, that is capable of transferring mass data between devices at high speed, while realizing low latency.

According to an embodiment of the present invention, there is provided a data transfer apparatus including a first virtual network device which is connected to a downstream port of a first device mounted with a serial transfer interface, a first cable for extending a downstream port of a second device mounted with a serial transfer interface, a second virtual network device which is connected to the first cable, a second cable for extending a downstream port of a third device mounted with a serial transfer interface, a third virtual network device which is connected to the second cable, and a virtual network switch which is connected to the first virtual network device, the second virtual network device and the third virtual network device.

The serial transfer interface may be a PCI Express (PCIe) and the first cable and the second cable may be each a PCIe cable.

The first virtual network device, the second virtual network service, the third virtual network device and the virtual network switch may be included in the first device.

The first virtual network device may be connected to the third cable for extending the downstream port of the first device.

According to another embodiment of the present invention, there is provided a data transfer apparatus including a first virtual network device which is connected to a downstream port of a first device mounted with a serial transfer interface, a second virtual network device as an endpoint device, a third virtual network device as a root complex device, and a virtual network switch which is connected to the first virtual network device, the second virtual network device and the third virtual network device, where the third virtual network device is connected by a cable to a forth virtual network device as an endpoint device in an second device mounted with a serial transfer interface.

The serial transfer interface may be a PCI Express (PCIe) and the cable may be a PCIe cable.

As described above, according to the present invention, it is possible to realize high-speed and low-latency mass data transfer between devices, while providing the apparatus having an inexpensive configuration.

### BRIEF DESCRIPTION OF THE DRAWINGS

FIG. 1 is an explanatory diagram illustrating a schematic configuration of a device mounted with a PCI Express;

FIG. 2 is an explanatory diagram illustrating data transfer between devices each mounted with a PCI Express by use of a network;

FIG. 3 is an explanatory diagram illustrating a configuration when PCIe buses of the devices each mounted with a PCI Express are drawn out by PCIe cables;

FIG. 4 is an explanatory diagram illustrating a configuration of a data transfer apparatus according to a first embodiment of the present invention;

FIG. 5 is an explanatory diagram illustrating a detailed configuration of the data transfer apparatus according to the first embodiment of the present invention;

FIG. 6 is an explanatory diagram illustrating a flow of data transfer between devices each mounted with a PCI Express by use of a network in section A and a flow of data transfer by use of the data transfer apparatus according to the first embodiment of the present invention in section B; and

FIG. 7 is an explanatory diagram illustrating a configuration of the data transfer apparatus according to a second embodiment of the present invention.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Explanation will be made in the following order.

1. Device mounted with PCI Express (PCIe)
2. Data transfer apparatus according to first embodiment of the present invention
3. Data transfer apparatus according to second embodiment of the present invention
[Device Mounted with PCI Express (PCIe)]

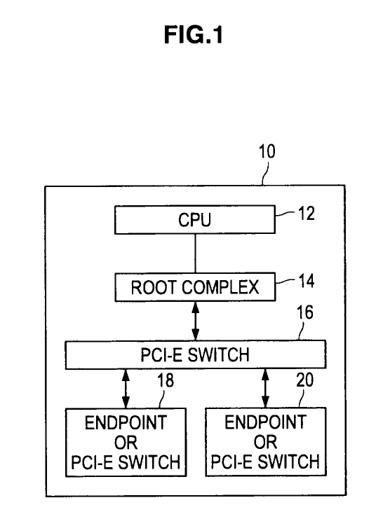

First, a device mounted with a PCI Express as a serial transfer interface will be explained. FIG. 1 is an explanatory diagram illustrating a schematic configuration of the device mounted with a PCI Express.

In FIG. 1, a device mounted with a PCI Express (PCIe) 10 includes a CPU 12, a root complex 14, a PCIe switch 16, and endpoints or PCIe switches 18, 20.

The root complex 14 is a device constituting the basis of a hierarchy, and may have one or more PCIe ports. The PCIe switch 16 is a device for adding the PCIe ports.

In the configuration of PCIe, the termination of a bus is always a downstream port, and in conformity with the PCIe standard of the PCI-SIG, only endpoints or PCIe switches 18, 20 may be connected to the downstream port.

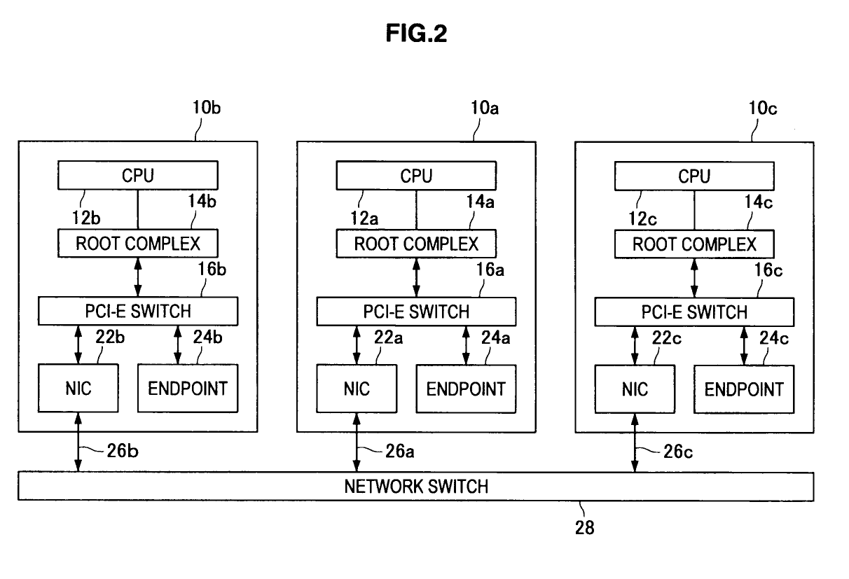

Next, Data transfer between devices each mounted with a PCI Express by use of network will be explained. FIG. 2 is an explanatory diagram illustrating data transfer between devices each mounted with a PCI Express by use of the network.

In FIG. 2, devices 10a, 10b, and 10c have PCIe topologies similarly to the device 10 of FIG. 1.

The device 10a includes a CPU 12a, a root complex 14a, a PCIe switch 16a, a Network Interface Card (NIC) 22a as a wideband network device which is an endpoint device, and an endpoint 24a. The device 10b includes a CPU 12b, a root complex 14b, a PCIe switch 16b, a NIC 22b, and an endpoint 24b. The Device 10c includes a CPU 12c, a root complex 14c, a PCIe switch 16c, a NIC 22c, and an endpoint 24c.

The NIC 22a of the device 10a is connected to a wideband network switch 28 by a network cable supporting wideband 26a. The NIC 22b of the device 10b is connected to the wideband network switch 28 by a network cable supporting wideband 26b. The NIC 22c of the device 10c is connected to the wideband network switch 28 by a network cable supporting wideband 26c.

As shown in FIG. 2, data transfer between the devices 10a, 10b and 10c may be carried out, by use of network cables supporting wideband and a wideband network switch, by inserting wideband network devices as endpoint devices to the corresponding PCIe downstream ports.

### [Data Transfer Apparatus According to First Embodiment of the Present Invention]

Next, a data transfer apparatus according to a first embodiment of the present invention will be explained. Between the above devices each mounted with a PCIe utilized is a network, due to limitations of a PCIe, as the only means that connects downstream ports of different devices to each other. In the present embodiment, an endpoint device constituting a virtual network is attached to a downstream port of one device, and connection between devices is established using not expensive network cables and an expensive network switch as in the above mentioned system of FIG. 2, but PCIe cables. Besides, a PCIe cable allows a PCIe bus to be drawn out to the outside through the cable and is standardized according to the PCIe standard of the PCI-SIG.

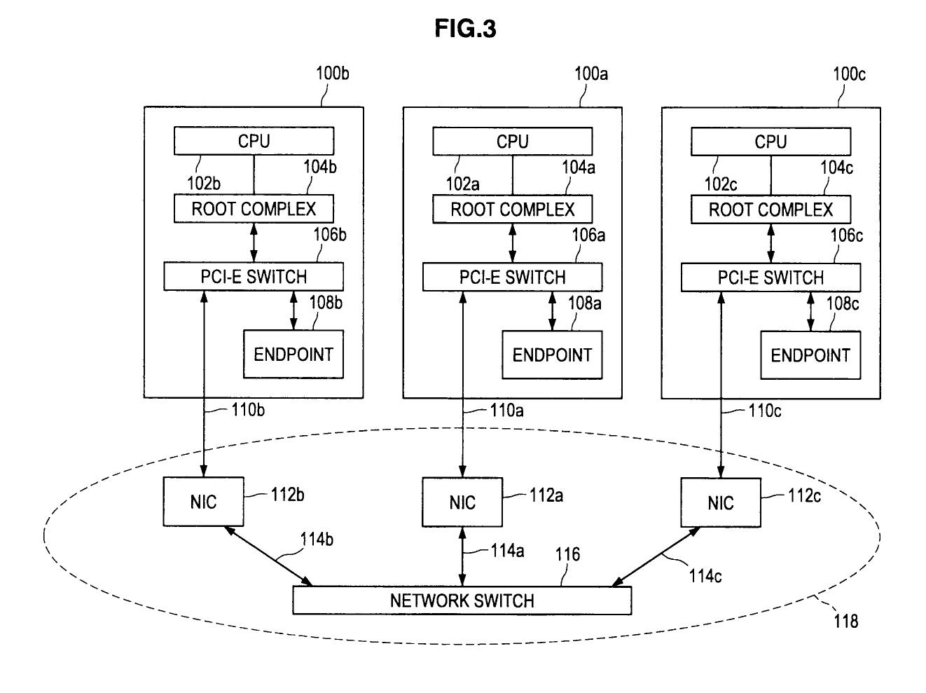

FIG. 3 is an explanatory diagram illustrating a configuration when PCIe buses of the devices each mounted with a PCI Express are drawn out by PCI cables. In FIG. 3, devices 100a, 100b and 100c have PCIe topologies similarly to the device 10 of FIG. 1.

The device 100a includes a CPU 102a, a root complex 104a, a PCIe switch 106a, and endpoint 108a. The device 100b includes a CPU 102b, a root complex 104b, a PCIe switch 106b, and an endpoint 108b. The device 100c includes a CPU 102c, a root complex 104c, a PCIe switch 106c, and an endpoint 108c.

In the device 100a, a PCIe downstream port is extended by a PCIe cable 110a so as to be drawn out to the outside, and a NIC 112a as a wideband network device which is an endpoint device is inserted into the end of the PCIe cable 110a. In the device 100b, a PCIe downstream port is extended by a PCIe cable 110b so as to be drawn out to the outside, and a NIC 112b as a wideband network device which is an endpoint device is inserted into the end of the PCIe cable 110b. In the device 100c, a PCIe downstream port is extended by a PCIe cable 110c so as to be drawn out to the outside, and a NIC 112c as a wideband network device which is an endpoint device is inserted into the end of the PCIe cable 110c.

Furthermore, the NIC 112a is connected to a wideband network switch 116 by a network cable supporting wideband 114a. The NIC 112b is connected to the wideband network switch 116 by a network cable supporting wideband 114b. The NIC 112c is connected to the wideband network switch 116 by a network cable supporting wideband 114c.

In the first embodiment of the present invention, a virtual network is configured by use of a single device or multiple devices in the section indicated by the dashed line 118, and thereby, the virtual network as a means that connects downstream ports of different devices to each other is provided.

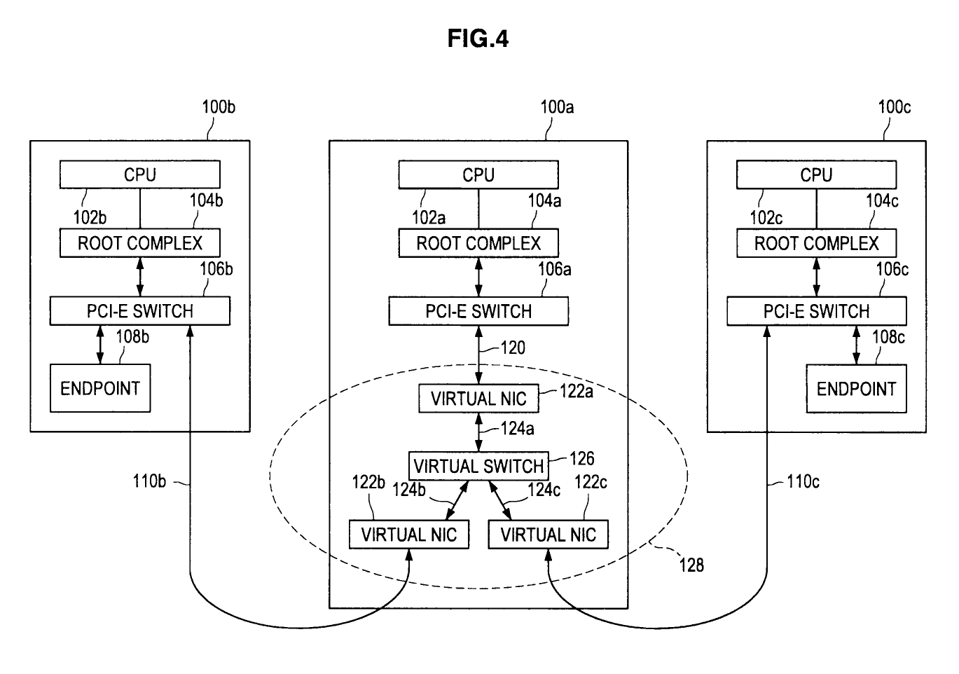

FIG. 4 is an explanatory diagram illustrating a configuration of the data transfer apparatus according to the first embodiment of the present invention. In FIG. 4, devices 100a, 100b and 100c have PCIe topologies similarly to the device 10 of FIG. 1.

A PCIe downstream port of the device 100b is extended by a PCIe cable 110b. A PCIe downstream port of the device 100c is extended by a PCIe cable 110c.

In the device 100a, a virtual network card (virtual NIC) 122a is connected to a PCIe downstream port 120. Further, a virtual NIC 122b is connected to the PCIe cable 110b. Furthermore, a virtual NIC 122c is connected to the PCIe cable 110c. The virtual NICs 122a to 122c are not real NICs but devices that are recognized by upper software as real network devices (NICs). These virtual NICs 122a to 122c are each connected to a virtual switch 126. The virtual switch 126 is a device having a function of transferring a signal from a virtual NIC to a given virtual NIC according to its own protocol. Besides, the virtual NICs 122a to 122c and the virtual switch 126 are connected with each other by physical signals 124a to 124c.

In FIG. 4, the virtual NICs 122a to 122c and the virtual switch 126 constitute a virtual network 128. Moreover, in FIG. 4, the virtual NIC 122a is directly connected to the downstream port, but the virtual NIC 122a may be extended by a cable so as to be drawn out to the outside.

In FIG. 4, when the device 100b is connected to the virtual NIC 122b of the device 100a by the PCIe cable 110b, the virtual NIC 122b in the device 100a is recognized as a network device by software of the device 100b. Further, when the device 100c is connected to the virtual NIC 122c of the device 100a by the PCIe cable 110c, the virtual NIC 122c in the device 100a is recognized as a network device by software of the device 100c. Furthermore, in the device 100a, because the virtual NIC 122a is already connected to a PCIe switch 106a of the 100a, software of the device 100a recognizes the virtual NIC 122a as a network device.

Normally, when data transfer is carried out by use of a network, application sends or receives data to or from a network device by Application Program Interface (API) called socket.

According to the first embodiment of the present invention, the virtual NICs are recognized as network devices by upper software, thereby allowing data transfer by API called Socket.

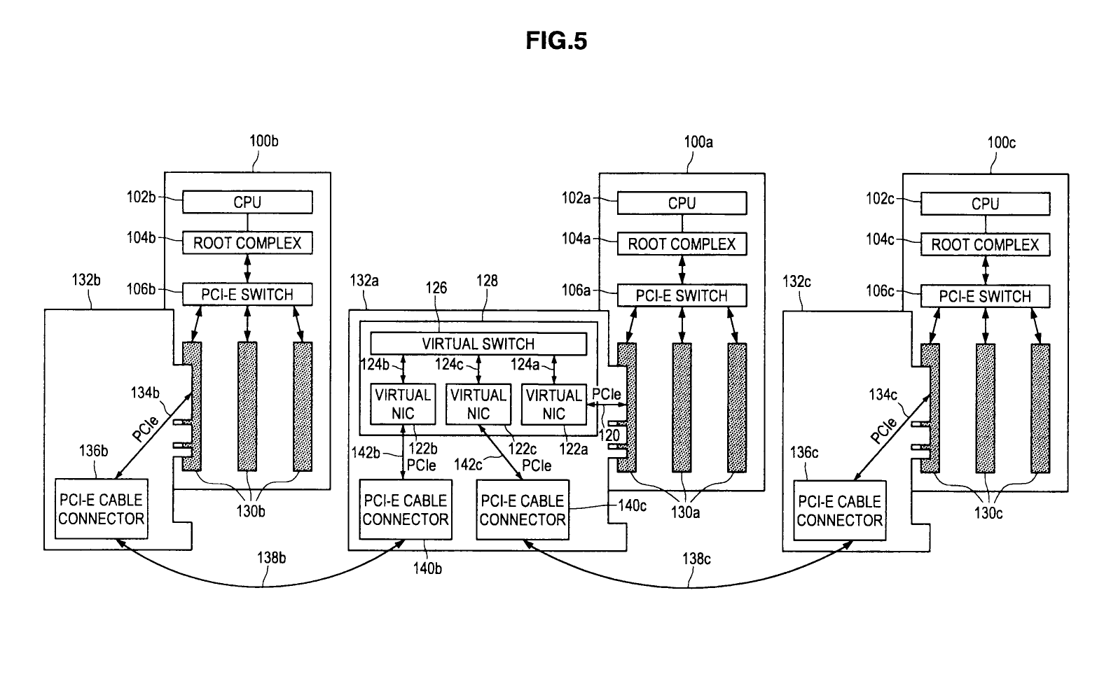

FIG. 5 is an explanatory diagram illustrating a detailed configuration of the data transfer apparatus according to the first embodiment of the present invention. In FIG. 5, the devices 100a, 100b and 100c have PCIe topologies similarly to the device 10 of FIG. 1.

A device 132a is inserted into a PCIe slot 130a of the device 100a. A device 132b is inserted into a PCIe slot 130b of the device 100b. A device 132c is inserted into a PCIe slot 130c of the device 100c.

In the device 132a, the virtual 122a in the virtual network 128 and the PCIe slot 130a are connected with each other by a PCIe lane 120. The virtual 122b in the virtual network 128 and a PCIe cable connector 140b are connected with each other by a PCIe lane 142b. The virtual 122c in the virtual network 128 and a PCIe cable connector 140c are connected with each other by a PCIe lane 142c. In the device 132b, a PCIe cable connector 136b and the PCIe slot 130b are connected with each other by a PCIe lane 134b. In the device 132c, a PCIe cable connector 136c and the PCIe slot 130c are connected with each other by a PCIe lane 134c.

Furthermore, the PCIe cable connector 140b of the device 132a and the cable connector 136b of the device 132b are connected with each other by a PCIe cable 138b. The PCIe cable connector 140c of the device 132a and the cable connector 136c of the device 132c are connected with each other by a PCIe cable 138c.

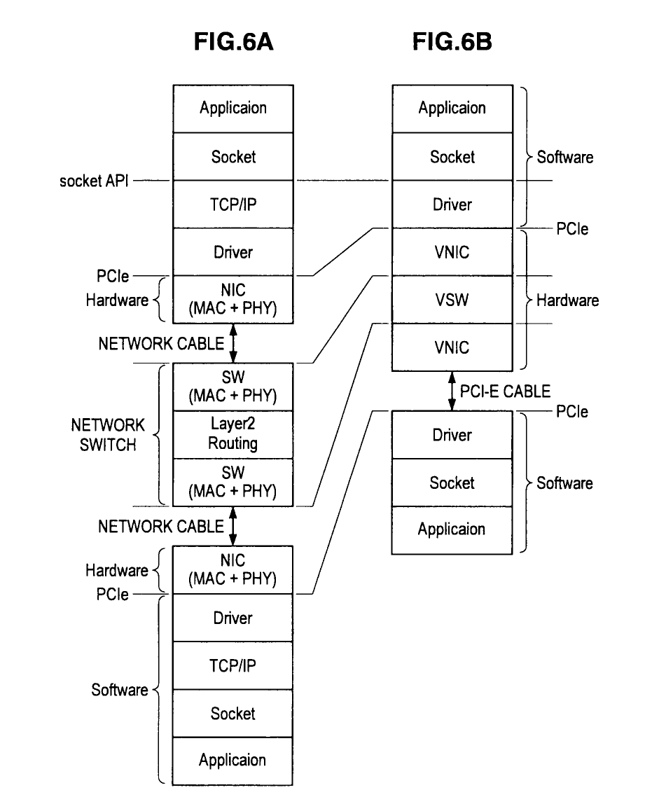

Next, a flow of data transfer between devices each mounted with a PCI Express. FIG. 6 is an explanatory diagram illustrating a flow of data transfer between devices each mounted with a PCI Express by use of a network in section A and a flow of data transfer by use of the data transfer apparatus according to the first embodiment of the present invention in section B.

As shown in section B of FIG. 6, a virtual NIC (VNIC) is recognized as a network device, which allows programming by API called Socket at the level of upper application. Thereby, it is possible to apply existing applications without any modification.

Furthermore, as shown in section A of FIG. 6, in the case of data transfer in the related art, latency grows bigger due to application of network protocols as represented by TCP/IP and the like, delay at a network switch, or the like.

According to the first embodiment of the present invention, the limitations due to network protocols such as TCP/IP and the like as described above and a network switch are not necessary, thereby allowing latency between devices to be lower in comparison with data transfer in the related art. Furthermore, it becomes possible to make full use of band of PCIe because there is no band-limiting due to a NIC, and thus a wideband configuration can be realized.

As described above, according to the first embodiment of the present invention, because devices are connected with each other by PCLe cables, expensive devices constituting a network in the related art are not used. Thereby, it is possible to realize low-cost data transfer between devices. Further, there are no limitations due to network protocols because virtual NICs and a virtual switch are used. Thereby, it is possible to realize low-latency data transfer between devices. Furthermore, because band of PCIe may be utilized to the full, it is possible to realize data transfer between devices in a wideband configuration.

Thus, according to the first embodiment of the present invention, it is possible to realize high-speed and low-latency mass data transfer between devices, while providing the apparatus in an inexpensive configuration.

Besides, in the first embodiment of the present invention above, an example is shown in which the present invention is applied to data transfer between three devices. However, the present invention may be applied to data transfer between two devices or between three or more devices.

### [Data Transfer Apparatus According to Second Embodiment of the Present Invention]

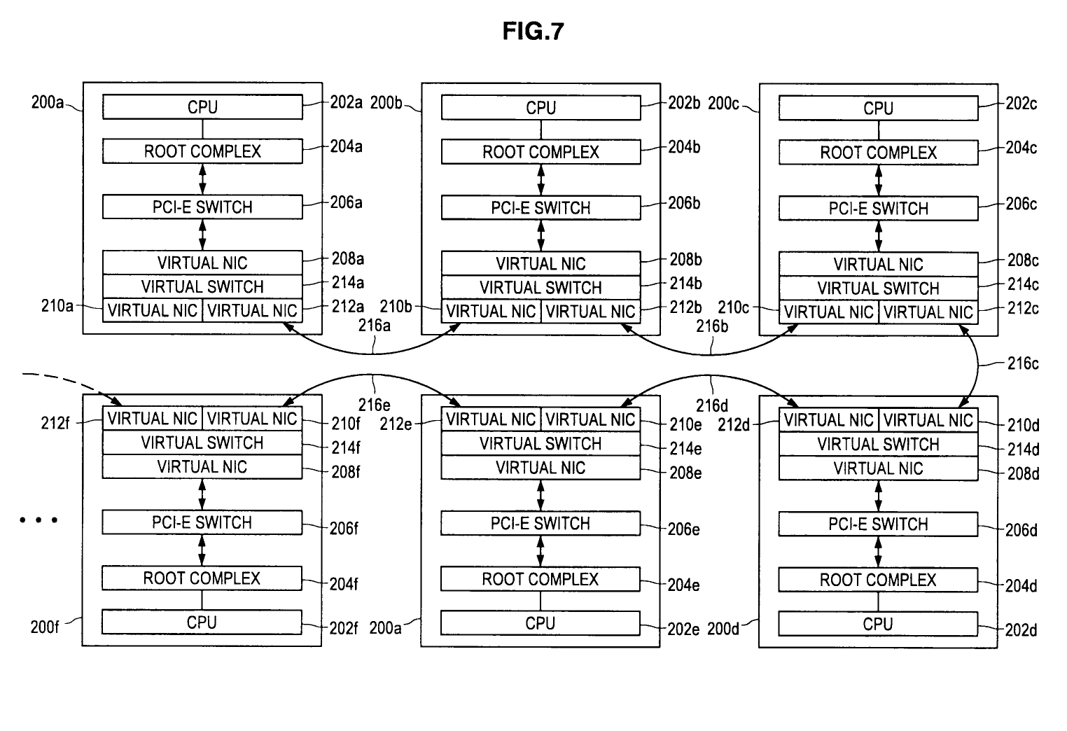

Next, a data transfer apparatus according to a second embodiment of the present invention. FIG. 7 is an explanatory diagram illustrating a configuration of the data transfer apparatus according to the second embodiment of the present invention. In FIG. 7, devices 200a to 200f have PCIe topologies similarly to the device 10 of FIG. 1.

The devices 200a to 200f include CPUs 202a to 202f, root complexes 204a to 204f, and PCIe switches 206a to 206f, respectively. Further, the devices 200a to 200f include virtual NICs 208a to 208f, 210a to 210f and 212a to 212f, and virtual switches 214a to 214f, respectively.

The virtual NICs 210a to 210f are endpoint devices, and the virtual NIC 212a to 212f are root complex devices. The virtual NIC 212a in the device 200a and the virtual NIC 210b in the device 200b are connected with each other by a PCIe cable 216a. The virtual NIC 212b in the device 200b and the virtual NIC 210c in the device 200c are connected with each other by a PCIe cable 216b. The virtual NIC 212c in the device 200c and the virtual NIC 210d in the device 200d are connected with each other by a PCIe cable 216c. The virtual NIC 212d in the device 200d and the virtual NIC 210e in the device 200e are connected with each other by a PCIe cable 216d. The virtual NIC 212e in the device 200e and the virtual NIC 210f in the device 200f are connected with each other by a PCIe cable 216e.

As shown in FIG. 7, by configuring a virtual NIC as a root complex device, it becomes possible to directly connect, for example, the virtual 212a of the device 200a and the virtual NIC 210b of the device 200b by the PCIe cable 216a. Thereby, as shown in FIG. 7, it becomes possible to add devices using the daisy chain method. Thus, the limitations in the number of the connected devices may be eliminated.

Furthermore, as shown in FIG. 7, devices are physically connected with each other only by a PCIe cable. Therefore, a network switch is no longer needed, which is used in a network configuration of the related art. Thus, it is possible to provide a low-cost configuration of the apparatus.

As described above, according to the second embodiment of the present invention, it is possible to realize high-speed and low-latency mass data transfer between devices in an inexpensive configuration, without limiting the number of the connected devices.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-251712 filed in the Japan Patent Office on Nov. 2, 2009, the entire content of which is hereby incorporated by reference.

What is claimed is:

1. A data transfer apparatus comprising:
a first virtual network device which is connected to a downstream port of a first device mounted with a serial transfer interface;
a first cable for extending a downstream port of a second device mounted with a serial transfer interface;
a second virtual network device which is connected to the first cable;
a second cable for extending a downstream port of a third device mounted with a serial transfer interface;
a third virtual network device which is connected to the second cable; and
a virtual network switch which is connected to the first virtual network device, the second virtual network device and the third virtual network device.

2. The data transfer apparatus according to claim 1,
wherein the serial transfer interface is a PCI Express (PCIe) and the first cable and the second cable are each a PCIe cable.

3. The data transfer apparatus according to claim 1,
wherein the first virtual network device, the second virtual network service, the third virtual network device and the virtual network switch are included in the first device.

4. The data transfer apparatus according to claim 1,
wherein the first virtual network device is connected to the third cable for extending the downstream port of the first device.

5. A data transfer apparatus comprising:
a first virtual network device which is connected to a downstream port of a first device mounted with a serial transfer interface;
a second virtual network device as an endpoint device;
a third virtual network device as a root complex device; and
a virtual network switch which is connected to the first virtual network device, the second virtual network device and the third virtual network device,
wherein the third virtual network device is connected by a cable to a forth virtual network device as an endpoint device in an second device mounted with a serial transfer interface.

6. The data transfer apparatus according to claim 5,
wherein the serial transfer interface is a PCI Express (PCIe) and the cable is a PCIe cable.
